(19) United States
(12) Patent Application Publication
(10) Pub. No.: US 2016/0127511 A1
(43) Pub. Date: May 5, 2016

(54) APPLICATION RANKING CALCULATING APPARATUS AND USAGE INFORMATION COLLECTING APPARATUS

(71) Applicant: THOMSON LICENSING, Issy-les-Moulineaux (FR)

(72) Inventors: Yanfeng ZHANG, Beijing (CN); Yuntao SHI, Beijing (CN); Jun XU, Beijing (CN)

(21) Appl. No.: 14/894,423

(22) PCT Filed: May 28, 2013
(86) PCT No.: PCT/CN2013/076348

§ 371 Date: Nov. 27, 2015

(51) Int. Cl. H04L 29/06; H04L 29/08

(52) U.S. Cl. CPC H04L 67/42; H04L 67/34

(57) ABSTRACT

An application ranking calculating apparatus is configured to calculate ranking for an application based on usage information from client computers on which the application is adapted to operate, the usage information representing how the application is actually used in the client computers.

### FIELD OF THE INVENTION

The present invention relates to an application ranking calculating apparatus, a usage information generating apparatus, etc.

### BACKGROUND

Patent Literature 1 discloses a score calculation system for measuring an evaluation of a user with respect to an evaluation object constituted of multiple tasks.

[Patent Literature 1] Japanese Laid-open Patent Publication No. 2011-238180

### SUMMARY

In the past several years, online application stores have experienced a soaring growth with the pervasive usage of mobile smart devices, such as smart phones, tablet PCs, etc. With very low barriers to entry, and low overhead digital distribution, companies and individual developers have been feverishly building, shipping and updating applications. The number of the applications available in online application stores is increasing exponentially. With such a huge number of applications, it is difficult for a user to find the exact application he/she wants, so these stores provide ranking or rating methods to help users to find the most popular applications. However, the current ranking or rating methods used by these stores are mainly based on an application's download history or a user's review rating. The download history can only provide a weak indication on whether an application is actually enjoyed by a user or not, because there is a possibility that the user just tried to download the application but actually never or seldom used it. In other words, there may be a case where the user loses his/her interest in the downloaded application immediately after having launched the application once. The user's rating also cannot fully indicate whether most users like the application or not, because the review rating requires a user's manual input and many users are reluctant to provide their review. And also, a user's review rating is too arbitrary.

Therefore, an object of this disclosure is to provide an application ranking calculating apparatus, etc., which can more appropriately calculate ranking for an application.

According to one aspect of the disclosure, an application ranking calculating apparatus is provided which is configured to calculate ranking for an application based on usage information from client computers on which the application is adapted to operate, the usage information representing how the application is actually used in the client computers.

According to the aspect of the disclosure, an application ranking calculating apparatus, etc., can be obtained which can more appropriately calculate ranking for an application.

### BRIEF DESCRIPTION OF DRAWINGS

FIG. 1 is a diagram for schematically illustrating a configuration of an application ranking calculating system 1.

FIG. 2 is a diagram for illustrating an example of a configuration of a usage information generating apparatus 200.

FIG. 3 is a diagram for illustrating an example of a configuration of an application ranking calculating apparatus 100.

FIG. 4 is a diagram for illustrating an example of a way of displaying the global rank values.

FIG. 5 is a flowchart for illustrating an example of a process executed by the usage information generating apparatus 200.

### DESCRIPTION OF REFERENCE SYMBOLS

1 application ranking calculating system
10 server
20 client computer
100 application ranking calculating apparatus
200 usage information generating apparatus

### DETAILED DESCRIPTION

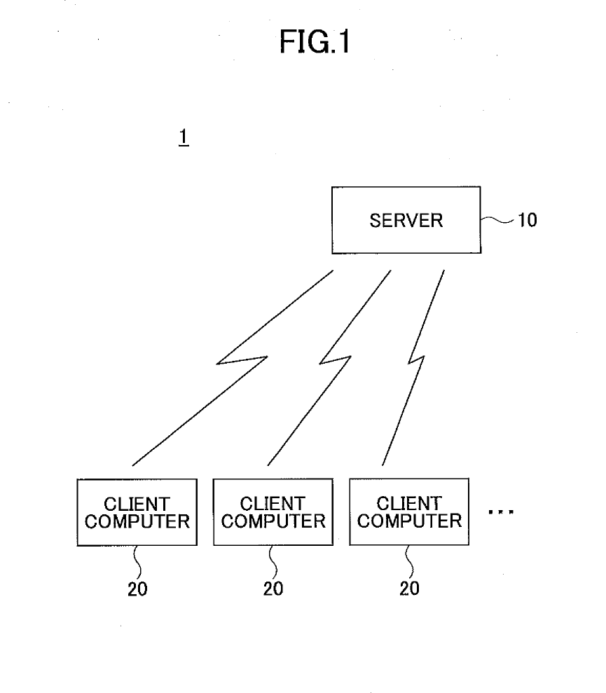

FIG. 1 is a diagram for schematically illustrating a configuration of an application ranking calculating system 1.

The application ranking calculating system 1 includes a server 10 and a plurality of client computers 20.

The server 10 can communicate with the client computers 20. The communication may be implemented in any manner. For example, the server 10 may communicate with the client computers 20 via wired communication, wireless communication, or a combination thereof.

The server 10 may include a computer which executes various processes to implement functions described hereinafter. The server 10 may be possessed and managed by an online application store.

The client computers 20 may be of any type, as long as they can operate applications stored therein and communicate with the server 10. The client computers 20 may be a tablet, a pad, a PDA (Personal Digital Assistant), a mobile telephone or other computing devices. The client computers 20 are typically mobile terminals; however, the client computers 20 may be desktop type computers, for example.

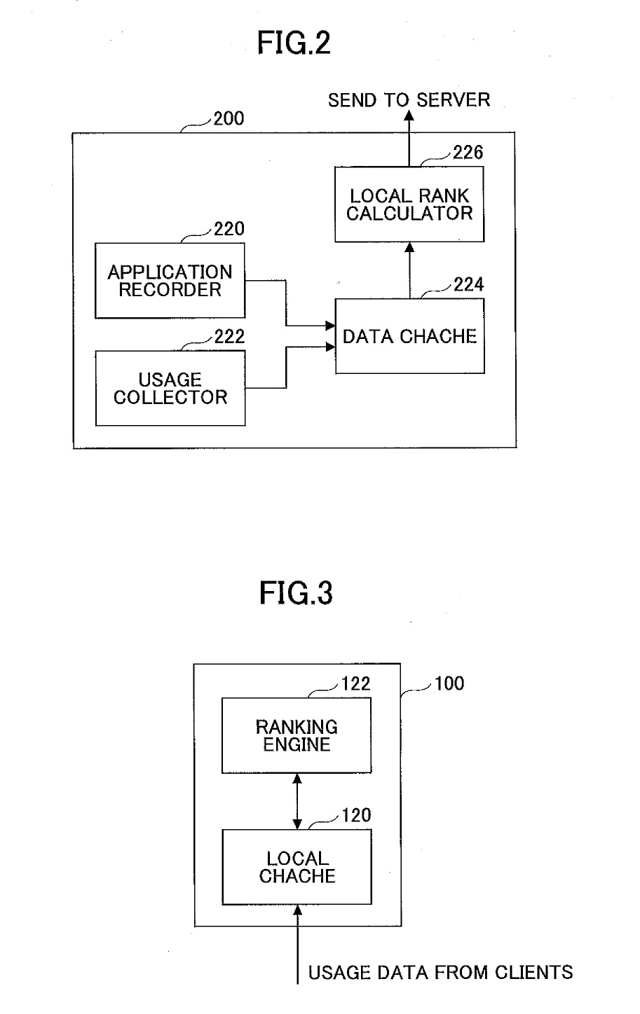

FIG. 2 is a diagram for illustrating an example of a configuration of a usage information generating apparatus 200.

The usage information generating apparatus 200 is typically provided in the client computer 20. In other words, the client computers 20 each includes the usage information generating apparatus 200. The usage information generating apparatus 200 may be implemented by any hardware resource, any software resource, or any combination thereof. In a typical embodiment, the usage information generating apparatus 200 is implemented when the client computer 20 executes usage information generating software. The usage information generating software may run in the client computer 20's background. The usage information generating software may start itself as the client computer 20 powers on. The usage information generating software may be provided by the server 10 to be installed in the client computers 20. The usage information generating software may be embedded into applications provided by the online application stores. In this case, the usage information generating software may be installed in the client computers 20 together with the application.

The usage information generating apparatus 200 may include an application recorder 220, a usage collector 222, a data cache 224, and a local rank calculator 226.

The application recorder 220 may record the applications which have been downloaded from the online application stores. The application recorder 220 may maintain an application list for these applications downloaded from the online application stores.

The usage collector 222 may monitor usage of the applications in the application list to generate usage data. In other words, the usage collector 222 may monitor how the applications in the application list are actually used in the client computer 20.

The usage data may indicate (in a given time period) how often the user uses it and how long the user interacts with it, that is to say, the frequency and duration of an application's usage. These two kinds of usage data items can provide a good estimate of how much a user likes to use the application in the most recent fixed period. To present how often the user uses the applications, the following data items may be recorded: launching times of an application in a fixed period (such as one day, one hour, etc.), the number of days the application has been used in a fixed couple of days (for example, a week, ten days, etc.).

The data cache memory 224 may store the application list from the application recorder 220 and the usage data from the usage collector 222.

The local rank calculator 226 may calculate a local rank value (local ranking) for each application based on the usage data in the data cache 224. The local rank calculator 226 may calculate the local rank value at any timing. For example, the local rank calculator 226 may calculate the local rank value periodically at predetermined intervals. The local rank calculator 226 may send the calculated local rank values to the ranking server. The local rank calculator 226 may send the calculated local rank values with the corresponding application names.

FIG. 3 is a diagram for illustrating an example of a configuration of an application ranking calculating apparatus 100.

The application ranking calculating apparatus 100 is typically provided in the server 10. In other words, the server 10 implements the functions of the application ranking calculating apparatus 100. The application ranking calculating apparatus 100 may be implemented by any hardware resource, any software resource, or any combination thereof.

The application ranking calculating apparatus 100 is configured to calculate, on an application basis, ranking (global ranking) for applications based on usage data from the client computers 20. In the example illustrated in FIG. 3, the application ranking calculating apparatus 100 includes a local cache 120 and a ranking engine 122.

The local cache memory 120 may store the rank values provided from the usage information generating apparatuses 200 of the client computers 20. In other words, the application ranking calculating apparatus 100 may receive the rank values from the usage information generating apparatuses 200, and store them in the local cache 120.

The ranking engine 122 may calculate, on an application basis, ranking (global ranking) for the applications. For example, the ranking engine 122 may calculate an average of the local rank values for the application to calculate the global rank value for the application. The average may be of any type, including moving average, weighted average or the like.

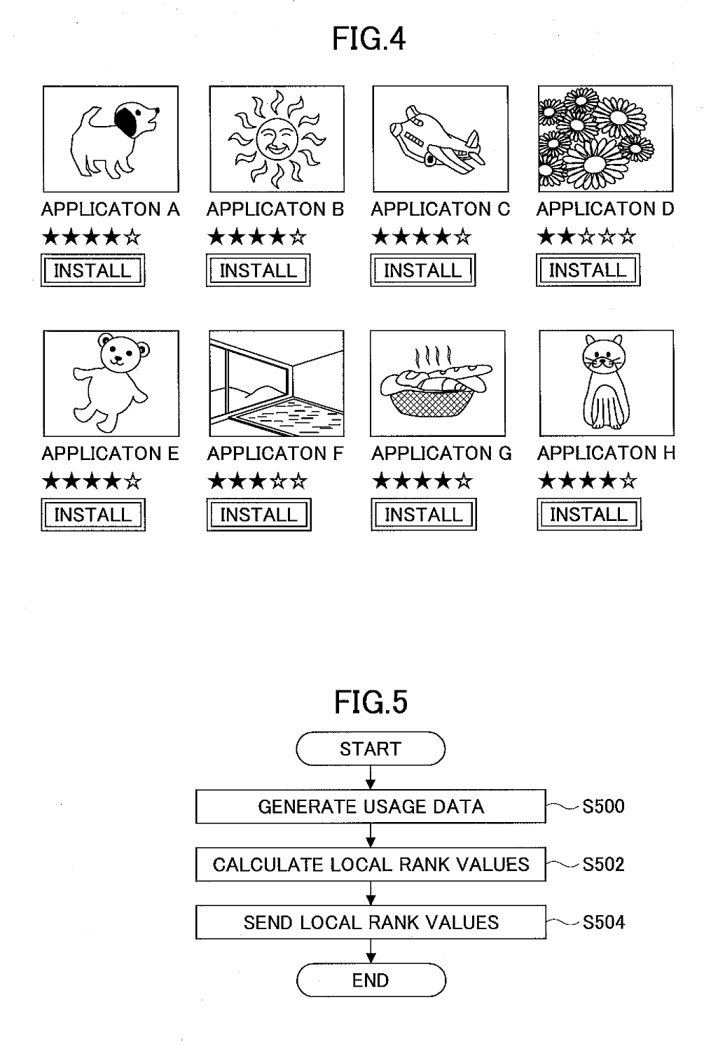

The ranking engine 122 may also calculate the nearest integer number around the averaged local rank value and use it as the ranked star number for the application. In this case, the server 10 may indicate the popularity of the application with the corresponding number of stars (see FIG. 4, for example).

According to the embodiment described above, the global rank values for the respective applications are calculated based on the usage data thereof. The usage data indicates how the applications are actually used in the client computers 20. This means that the usage data indicates how much the respective applications are liked by the users. In other words, the usage data reflect the public favor more precisely than other factors such an application's download history. Therefore, using the usage data makes it possible to more appropriately calculate global rank values for the respective applications. Further, the usage data can be collected without asking the users to do special operations (such as asking the users to submit their review ranking). In other words, the usage data can be generated (collected) based on information obtained when the application is actually operated. Thus, the usage data can be collected (automatically) from a wide range of the users (client computers 20). Therefore, using the usage data makes it possible to more appropriately calculate global rank values for the respective applications.

It is noted that, in the embodiment described above, the global rank values for the respective applications are calculated not directly based on the usage data but indirectly on the usage data. In other words, the global rank values are calculated based on the local rank values which are derived based on the usage data. However, the global rank values for the respective applications may be directly based on the usage data. In this case, the function of the local rank calculator 226 may be implemented by the application ranking calculating apparatus 100 in the server 10. Alternatively, as an equivalent embodiment, the ranking engine 122 may calculate the global rank values directly from the usage data (i.e., without calculating the local rank values).

FIG. 4 is a diagram for illustrating an example of a way of displaying the global rank values.

The global rank values for the respective applications calculated by the ranking engine 122 may be output in any manner. The global rank values may be output in a display of the client computer 20 when the client computer 20 accesses the online application store (i.e., the server 10) to buy (install) the application.

In the example illustrated in FIG. 4, the global rank values are displayed with the corresponding application names (“APPLICATION A”, “APPLICATION B”, etc.). The global rank values are expressed by a star number. The star number indicates the popularity of the application. The more popular the application becomes, the higher the star number given to the application becomes (five (5) is the maximum and zero (0) star is the minimum, for this example). For example, the APPLICATION A has four stars while the APPLICATION D has only two stars.

It is noted that the global rank values may be expressed by other indications. For example, the global rank values may be expressed by a numeral.

With this arrangement, the users can select his/her favorite application, among an enormous number of applications, more easily by relying on the global rank values. It is noted that, in the example illustrated in FIG. 4, only eight applications are presented to the user; however, as is the case with ordinary online application stores, the applications displayed may be changed in response to inputs in the client computers 20. For example, the users can narrow the candidates of the applications by inputting search conditions. Further, the applications with the same category may be presented in decreasing order of the global rank values.

FIG. 5 is a flowchart for illustrating an example of a process executed by the usage information generating apparatus 200. As described above, the process may be implemented by the client computer 20 when executing the usage information generating software.

In step S500, the usage collector 222 generates the usage data on an application basis. The usage data is generated with respect to the respective applications listed in the application list stored in the data cache 224. The usage collector 222 may generate the usage data based on log data (history data). Alternatively, the usage collector 222 may be initiated whenever any application is launched to generate the usage data. The usage data thus generated is stored in the data cache 224.

In step S502, the local rank calculator 226 calculates the local rank value for each application based on the usage data in the data cache 224. As a result of this, the local rank values for the respective applications listed in the application list are derived. The process in step S502 may be initiated at any timing. For example, the process in step S502 may be initiated periodically at predetermined intervals. Alternatively, the process in step S502 may be initiated when the client computer 20 is turned on.

In step S504, the local rank calculator 226 sends the calculated local rank values as usage information to the server 10. Specifically, the local rank calculator 226 may send the calculated local rank values with the corresponding application names and a device ID (an ID of the client computer 20) to the server 10. It is noted that to preserve the user's privacy, only the device ID is used to identify the user of the application. Using the device ID guarantees that each client computer 20 can only upload the local ranking information to the server once for a fixed time. It is noted that the process in step S504 may be performed subsequent to the process in step S502.

According to the process in FIG. 5, the local rank values can be calculated without requiring user's manual input. In other words, the local rank values can be automatically generated by the usage information generating apparatus 200. Thus, the local rank value for each application can be collected from a number of usage information generating apparatus 200 (i.e., a number of users). Therefore, the reliability of the calculated global rank value for each application can be increased.

It is noted that in the case of a configuration where the application ranking calculating apparatus 100 calculates the global rank values directly based on the usage data, the process of step S502 may be omitted. In this case, in step S504, the usage data, instead of the local rank values, may be sent to the server 10.

Next, an example of a way of calculating the local rank values for the applications is described.

Here it is assumed that the usage collector 222 may record, on an application basis, the launching times of the application in a predetermined time period T1 (one day, one hour, etc., for example), an operation duration which presents a sum of time (moments) during which the application is run in a predetermined time period T2 (one day, one hour, etc., for example), and the number of usage days in a predetermined time period T3 (one week, ten days, etc., for example).

The factor “launching times” represents how many times a user launches an application in a given period. If the user launches a certain application many times within the period, the application may be his/her favorite with a high probability.

The factor “operation duration” represents the sum of time during which the application is operated (i.e., the user interacts with the application) in a given period. If the user launches an application and interacts with it for a long time during this period, the application may be his/her favorite with a high probability.

The factor “the number of usage day” represents how often a user launches an application on a daily basis. If a user uses an application everyday or for most days in the couple of days, the application may be his/her favorite with a high probability, even though in each day, he/she uses the application just once or several times and interacts with it for a short time.

In this case, the local rank value for the applications may be calculated as follow. Given m applications downloaded from a certain application store which is managed by the server 10 (the number of the applications and their application list are stored in the data cache 224), the launching times for the applications are {N₁, N₂, . . . Nₘ}, the operation duration for the applications are {T₁, T₂, . . . Tₘ}, and the number of usage days for the applications are {D₁, D₂, . . . Dₘ}. Nᵢ(1≦i≦m) represents the launching times in one day, and Tᵢ(1≦i≦m) represents the sum of interactive moments in one day. Using one day as the given time period enables the usage information generating apparatus 200 to calculate and upload local rank values once a day; however, it can be replaced with other fixed periods, for example, one hour, one week, etc. Dᵢ(1≦i≦m) represents the number of days in which the user has used the application in the recent fixed couple of days, for example, a week, 10 days, or a month, etc.

With this collected usage data, the usage information generating apparatus 200 may calculate the local rank value Rᵢ for a certain application i with the following function periodically:

$${R}_{i} = 5 \times max \{ \frac{{N}_{i}}{{N}_{max}} , \frac{{T}_{i}}{{T}_{max}} , \frac{{D}_{i}}{{D}_{max}} \}$$

Where Rᵢ is the calculated local rank value for application i, N_{MAX} is the maximal value of {N₁, N₂, . . . Nₘ}, T_{MAX} is the maximal value of {T₁, T₂, . . . Tₘ}, and D_{MAX} is the maximal value of

$$\{ {D}_{1} , {D}_{2} , … {D}_{m} \} . \frac{{N}_{i}}{{N}_{max}}$$

represents the rank value for application i if only the usage data of the launching time is considered (the most launched application gets a score of “one”, same for the other two items in the above function);

$$\frac{{T}_{i}}{{T}_{max}}$$

represents the local rank value for application i if only the usage data of the operation duration is considered; and

$$\frac{{D}_{i}}{{D}_{max}}$$

represents the local rank value for application i if only the usage data of usage days is considered. A coefficient “5” is used to give the highest ranked application a five-star symbol. Using the maximal value of

$$\{ \frac{{N}_{i}}{{N}_{max}} , \frac{{T}_{i}}{{T}_{max}} , \frac{{D}_{i}}{{D}_{max}} \}$$

is due to the fact that any one of the three factors can individually indicate whether the user likes the application or not.

It is noted that, in the example described above, m applications may be all the applications downloaded from the application store. Alternatively, m applications may be applications which have been downloaded from the application store and have the same category. In this case, N_{MAX}, T_{MAX}, and D_{MAX} are calculated on a category basis. In this case, it becomes possible to consider the difference in characteristics of the applications in calculating the local rank values. For example, some applications are intended to be used regularly once a day, while other applications are intended to be used at irregular intervals.

It is noted that, in the example described above, three factors, that is to say, the “launching times”, the “operation duration”, and “the number of usage days” are used to calculate the local rank values. However, only one of these factors may be used to calculate the local rank values. For example, if only the “launching times” is used, the local rank value Rᵢ may be calculated as follows:

$${R}_{i} = 5 \times \frac{{N}_{i}}{{N}_{max}}$$

Further, any two of these factors may be used to calculate the local rank values. For example, if only the “launching times” and the “operation duration” are used, the local rank value Rᵢ may be calculated as follows:

$${R}_{i} = 5 \times max \{ \frac{{N}_{i}}{{N}_{max}} , \frac{{T}_{i}}{{T}_{max}} \}$$

Further, an additional factor(s) may be considered to calculate the local rank values. For example, the application's download history or user's review rating may be considered in addition to the factors described above.

Further, in the example described above, three factors are considered equally to calculate the local rank values. However, three factors may be assigned respective weights. In this case, the weights may be changed, on an application basis, based on characteristics of the respective applications. For example, if a certain application is intended to be used daily, the weight assigned to the factor “the number of usage day” may be greater than that assigned to other factors.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

1. An application ranking calculating apparatus configured to calculate global ranking for an application based on a local rank values from client computers on which the application is adapted to operate, wherein the local rank values are being calculated by the respective client computers for the application based on usage information representing how the application is actually used in the client computers.

2. The apparatus of claim 1, wherein the usage information is automatically generated, based on information obtained when the application is actually operated, by a software installed in the respective client computers.

3. The apparatus of claim 1, wherein the local rank values are calculated based on the usage information related to at least one of launching times of the application in a time period, an operation duration which represents a sum of time during which the application is run in a time period, and the number of usage days in a time period.

4. The apparatus of claim 3, wherein the local rank values are calculated at least either by dividing the launching times of the application by the maximal value of the launching times of all the applications in the client computer, dividing the operation duration of the application by the maximal value of the operation duration of all the applications in the client computer, or dividing the number of usage days of the application by the maximal value of the number of usage day of all the applications in the client computer.

5. A usage information generating apparatus provided in a client computer, the usage information generating apparatus being configured to generate usage information and send the generated usage information to a server for calculation of global ranking for an application, wherein the usage information includes a local rank values for the application being calculated by the respective client computers and represents how an application is actually used in the client computers.

6. The apparatus of claim 5, wherein the usage information is automatically generated, based on information obtained when the application is actually operated, by a software installed in the respective client computers.

7. The apparatus of claim 5, wherein the local rank values are calculated based on at least one of launching times of the application in a time period, an operation duration which presents a sum of time during which the application is run in a time period and the number of usage days in a time period.

8. The apparatus of claim 7, wherein the local rank values are calculated at least either by dividing the launching times of the application by the maximal value of the launching times of all the applications in the client computer, dividing the operation duration of the application by the maximal value of the operation duration of all the applications in the client computer, or dividing the number of usage days of the application by the maximal value of the number of usage day of all the applications in the client computer

9. A method performed in a server, comprising:
obtaining usage information from client computers on which an application is adapted to operate, wherein the usage information includes a local rank values being calculated by respective client computers for the application and represents how the application is actually used in the client computers; and
calculating global ranking for the application based on the local rank values.

10. The method of claim 9, wherein the usage information is automatically generated, based on information obtained when the application is actually operated, by a software installed in the respective client computers.

11. The method of claim 9, wherein the local rank values are calculated based on at least one of launching times of the application in a time period, an operation duration which presents a sum of time during which the application is run in a time period and the number of usage days in a time period.

12. The method of claim 11, wherein the local rank values are calculated at least either by dividing the launching times of the application by the maximal value of the launching times of all the applications in the client computer, dividing the operation duration of the application by the maximal value of the operation duration of all the applications in the client computer, or dividing the number of usage days of the application by the maximal value of the number of usage day of all the applications in the client computer

13. A method performed in a client computer, comprising:
generating usage information representing how an application is actually used in the client computer];
calculating a local rank values for an application based on the usage information and
sending the local rank values to a server for calculation of global ranking for the application.

14. The method of claim 13, wherein the usage information is automatically generated, based on information obtained when the application is actually operated, by a software installed in the respective client computers.

15. The method of claim 13, wherein the local rank values are calculated based on the usage information related to at least one of launching times of the application in a time period, an operation duration which presents a sum of time during which the application is run in a time period and the number of usage days in a time period.

16. The method of claim 15, wherein the local rank values are calculated at least either by dividing the launching times of the application by the maximal value of the launching times of all the applications in the client computer, dividing the operation duration of the application by the maximal value of the operation duration of all the applications in the client computer, or dividing the number of usage days of the application by the maximal value of the number of usage day of all the applications in the client computer

17. A computer readable program that, when executed on a computer, causes the computer to implement:
obtaining usage information from client computers on which an application is adapted to operate, wherein the usage information includes a local rank values being calculated by the respective client computers for the application and represents how the application is actually used in the client computers; and
calculating global ranking for the application based on the local rank values.

18. Non-transitory computer-readable medium comprising a computer program product recorded thereon and capable of being run by a processor, including program code instructions for implementing:
obtaining usage information from client computers on which an application is adapted to operate, wherein the usage information includes a local rank values being calculated by the respective client computers for the application and represents how the application is actually used in the client computers; and
calculating global ranking for the application based on the local rank values.
